(19) United States
(12) Patent Application Publication
(10) Pub. No.: US 2019/0217903 A1
(43) Pub. Date: Jul. 18, 2019

(54) Box for Pick-up Truck Vehicles

(71) Applicant: Jaime MARIMON DE LA MORENA, BARCELONA (ES)

(72) Inventor: Jaime MARIMON DE LA MORENA, BARCELONA (ES)

(21) Appl. No.: 15/873,243

(22) Filed: Jan. 17, 2018

(51) Int. Cl. B62D 33/03; B60J 5/04

(52) U.S. Cl. CPC B62D 33/03; B60J 5/0497

(57) ABSTRACT

A box for vehicles of the pick-up type comprising a cargo bed delimited by two substantially vertical side panels, a front panel, and a movable tailgate for loading and unloading. The box includes, on at least one of the side panels, an auxiliary gate fixed to said side panel by supporting means and is able to be displaced between a closed position, in which said auxiliary gate is arranged coplanar with said side panel, and an open position, in which, in said side panel, it defines a space for loading and unloading.

### FIELD OF THE INVENTION

The field of the present invention falls within the automotive sector focusing particularly in the area of the industry dedicated to the manufacture of boxes for pick-up truck vehicles.

### BACKGROUND

Currently, pick-up truck vehicles equipped with a cabin for the driver and one or more accompanying passengers, and a rear box delimited by two substantially vertical side panels, a front panel and a hinged rear tailgate for loading and unloading, are widely known.

Depending on the maneuverability of the vehicle, the loading and unloading operations through the rear area of the box may be especially difficult due to the lack of adequate space to access said rear area.

Therefore, the technical problem posed is the development of a box for pick-up truck vehicles having, in addition to a rear tailgate, at least one auxiliary gate to define a side loading and unloading area.

### SUMMARY

An object of the present invention relates to a box for vehicles, in particular pick-up truck vehicles, which provides a number of advantages and structural and constitutive features that will be described in detail below, and which involve an improvement over what is already known in the state of the art.

Specifically, the object of the invention focuses on a box for pick-up truck vehicles including features designed to facilitate loading and unloading through at least one side of the vehicle's box.

The box for vehicles proposed by the invention is configured as a novel item within its field of application, since it presents appropriate features to achieve the objective proposed, the characterizing details which distinguish it being defined in the appended claims.

Specifically, what the invention proposes is a box for vehicles, particularly pick-up truck vehicles, including a cargo bed delimited by two, substantially vertical, side panels, a front panel, and a movable tailgate for loading and unloading.

According to the invention, at least one of the side panels has an auxiliary gate attached to said side panel by supporting means and is able to be displaced between a closed position, in which said auxiliary gate is arranged coplanar with the rest of the side, and an open position, in which it defines, in said side panel, a space for loading and unloading.

In one embodiment of the invention the supporting means for the auxiliary gate comprise hinges for its side folding between a vertical closed position and a horizontal open position.

In order to minimize the space taken by the auxiliary gate in the open position, in one embodiment of the invention the vehicle box comprises, below the cargo bed, transverse guides for the displacement and concealment of said auxiliary gate in the horizontal open position.

In any case, the auxiliary gate can be manually operated, although the invention also contemplates the possibility that the box is provided with driving means for the displacement of the auxiliary gate between the open and closed positions.

### BRIEF DESCRIPTION OF THE FIGURES

In order to complement the description that is being carried out and with the purpose of facilitating the understanding of the features of the invention, the present description is accompanied by a set of drawings wherein, by way of a non-limiting example, the following has been represented:

FIG. 1 shows a perspective schematic view of a vehicle of the pick-up type with the box, object of the invention, having on one of its sides the manually operated auxiliary gate.

FIG. 2 show a profile schematic view of the embodiment of the previous figure, in which the manually operated auxiliary gate is mounted on folding hinges; said auxiliary gate having been represented with a continuous line in the closed position and dotted line in the open position.

FIG. 3 shows a variant of the embodiment of FIG. 2, in which the box is provided with driving means for the operation of the auxiliary gate.

FIG. 4 shows a profile schematic view of a second embodiment of the invention, in which, below the cargo bed, the box has guides for the concealment of the auxiliary gate in the open position. In said figures the auxiliary gate has been shown in an open position and in a closed position respectively.

FIG. 5 shows another profile schematic view of a second embodiment of the invention, in which, below the cargo bed, the box has guides for the concealment of the auxiliary gate in the open position. In said figures the auxiliary gate has been shown in an open position and in a closed position respectively.

### PREFERRED EMBODIMENT OF THE INVENTION.

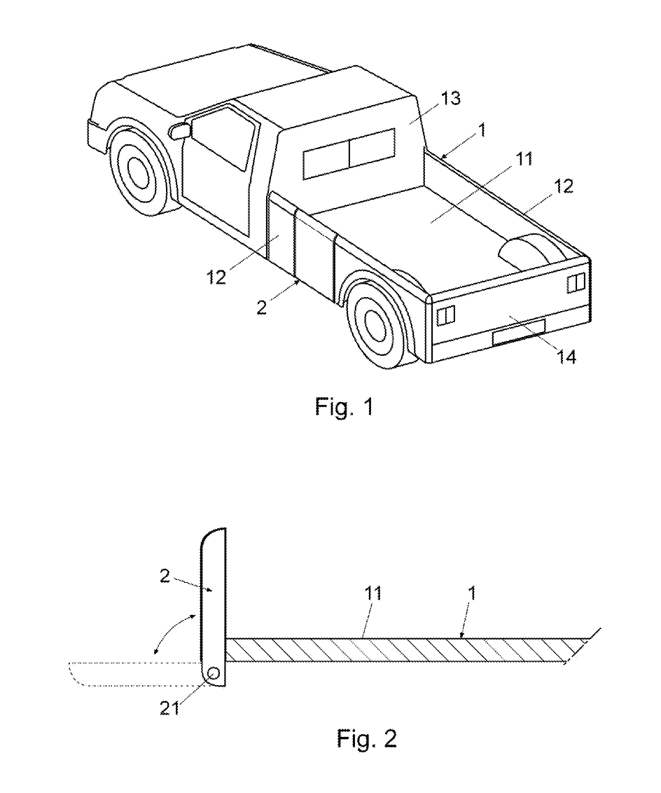

In FIG. 1 a pick-up truck vehicle with the box (1) of the invention is shown. Said box (1) comprises a cargo bed (11) delimited by two substantially vertical side panels (12), a front panel (13) and a movable tailgate (14) for loading and unloading.

In said FIG. 1, one of the side panels (12) has an auxiliary gate (2) for side loading and unloading.

In FIG. 2, said auxiliary gate (2) is fixed to the side panel (12) by supporting means consisting of hinges (21) which allow its manual side folding between a vertical closed position, in which said auxiliary gate (2) is arranged coplanar with the rest of the side panel (12), and a horizontal open position, leaving defined in the side panel (12) a space for loading and unloading.

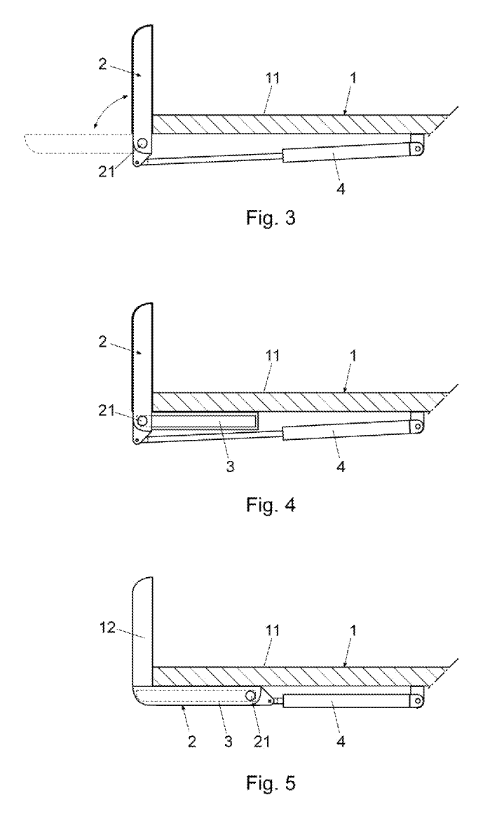

In FIG. 3, a variant of the embodiment of FIG. 2 is shown, in which the box incorporates driving means (4) represented by an electric driving cylinder for the displacement of the auxiliary gate (2) between the open and closed positions.

In the embodiment shown in FIGS. 4 and 5 the box (1) comprises, below the cargo bed (11), transverse guides (3) for the displacement and concealment of the auxiliary gate (2) in the horizontal open position.

In this embodiment the box (1) also comprises driving means (4), represented by an electric driving cylinder, which when operated cause the displacement of the auxiliary gate (2) between the open and closed positions.

Once the nature of the invention as well as an example of preferred embodiment have been sufficiently described, it is stated for all pertinent purposes that the materials, form, size and arrangement of the elements described are susceptible to changes, provided these do not involve an alteration of the essential features of the invention that are claimed subsequently.

1. A box for pick-up truck vehicles comprising:
a cargo bed delimited by two substantially vertical side panels, a front panel and a movable tailgate for loading and unloading, wherein at least one of the side panels has an auxiliary gate fixed to the side panel by supporting means and is able to be displaced between a closed position, in which the auxiliary gate is arranged coplanar with said side panel, and an open position, in which, in the side panel, it defines a space for loading and unloading.

2. The box for pick-up truck vehicles according to claim 1, wherein the supporting means for the auxiliary gate comprise hinges for its side folding between a vertical closed position and a horizontal open position.

3. The box for pick-up truck vehicles according to claim 2, further comprising, below the cargo bed, transverse guides for the displacement and concealment of the auxiliary gate in a horizontal open position.

4. The box for pick-up truck vehicles according to claim 1, wherein the auxiliary gate is manually operated.

5. The box for pick-up truck vehicles according to claim 1, further comprising driving means which, when operated, cause the displacement of the auxiliary gate between the open and closed positions.
